(19) United States
(12) Patent Application Publication
(10) Pub. No.: US 2006/0027986 A1
(43) Pub. Date: Feb. 9, 2006

(54) Method and apparatus for a rear wheel steer system for a vehicle

(76) Inventor: James F. Ziech, Kalamazoo, MI (US)

Correspondence Address: MARSHALL & MELHORN, FOUR SEAGATE, EIGHT FLOOR, TOLEDO, OH, 43604, US

(21) Appl. No.: 10/910,411

(22) Filed: Aug. 3, 2004

(51) Int. Cl. B62D 7/18

(52) U.S. Cl. 280/93.512

(57) ABSTRACT

A method and apparatus for adding steering capability to a rear driven or non-driven axle is described. The invention utilizes many of the existing rear axle components, such as the upper control arm, lower control arm and knuckle. A gimbal is added to connect the lower control arm with the frame. A tie rod, or a slot and cam system, connects the lower control arm with at least one actuator to selectively turn the knuckle.

### FIELD OF THE INVENTION

The present invention relates to a method and apparatus for a rear wheel steer system for a vehicle.

### BACKGROUND OF THE INVENTION

Systems for steering the driven or non-driven rear wheels of a vehicle are well known. For example, U.S. Pat. No. 2,103,624 teaches wheels fitted on stub axles pivotally connected to transverse axles with universal joints. The universal joints are accommodated in steering heads. The steering heads have arms connected to bell crank levers through links. The bell crank levers are connected to steering arms. The steering arms are connected to a pair of levers operated from the steering wheel, thus providing a steering input to the wheels.

U.S. Pat. No. 2,819,769 provides for a suspension system where all four wheels are driven and steerable. Each rear wheel is supported by a lower control arm and an upper control arm. The upper and lower control arms are connected together by a king pin and ball joints. The king pin is connected to a wheel stub shaft with a universal joint. A rear differential assembly is connected to the wheel stub shaft to provide rotation thereto. In order to turn the rear wheels, a hydraulic motor is connected to a tie rod which is connected to a steering arm. A plurality of switches are connected to the front steerable wheels so that when they are turned past a predetermined position, the switches are engaged. In the engaged position, the switches energize the hydraulic motor. The motor provides hydraulic fluid to push the tie rod and thus the steering arm of the wheel.

U.S. Pat. No. 4,709,935 depicts and describes a rear wheel suspension having steering and drive mechanisms. Standard upper and lower links are taught to be attached to the hub carrier/knuckle with an upper and a lower ball joint, respectively. The steering system comprises an actuator having a cylinder with a fluid driven piston. A tie rod is connected to the piston. The tie rod is pivotally connected to a trailing arm of the suspension. The rear steering mechanism is actuated by a series of fluid switches that transmit fluid through fluid lines to the piston in response to changes in the position of the steering wheel.

U.S. Pat. No. 4,796,720 generally teaches a steerable rear wheel mechanism with an eccentric cam operated wheel camber control system physically connected to a steerable front wheel mechanism. Specifically, a rear steering shaft is connected to the steering wheel for transmitting steering wheel inputs to the rear wheel mechanism. The rear steering shaft is connected to a rear rack and pinion system comprising a left and right tie rod.

In light of the above-described prior art designs that require complex additional components to steer the rear wheels of a vehicle, it would be advantageous to have a steering system for the rear wheels of a vehicle that utilized much of the existing wheel and suspension equipment.

### SUMMARY OF THE INVENTION

The present invention is directed toward a rear wheel steer system that utilizes the existing vehicle frame, the vehicle knuckle, the upper control arm and the lower control arm. The pivotal connection of the lower control arm to the knuckle remains, but a gimbal is added between the knuckle and the frame. A tie rod is attached to an inboard portion of the lower control arm. The tie rod is connected to an actuator.

The present invention is also directed toward a method of steering the rear wheel steer system including translating the tie rod in either an inboard or an outboard direction with the actuator. The translation rotates the lower control arm about the gimbal, thus urging the knuckle to rotate in the same direction.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a perspective, schematic view of an embodiment of the present invention;

FIG. 2 is a partial, top, schematic view of the invention depicted in FIG. 1;

FIG. 3 is an perspective, schematic view of an alternative embodiment to the invention depicted in FIG. 1;

FIG. 4 is a top, schematic view of the present invention depicted in FIG. 1;

FIG. 5 is a perspective, schematic view of an alternative embodiment of the present invention;

FIG. 6 is a perspective, schematic view of an alternative embodiment to the invention depicted in FIG. 5;

FIG. 7 is a perspective, schematic view of the invention depicted in FIG. 1 illustrating a rotation of the invention about an axis; and

FIG. 8 is a cross-sectional view of a component of the invention depicted in FIG. 5.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

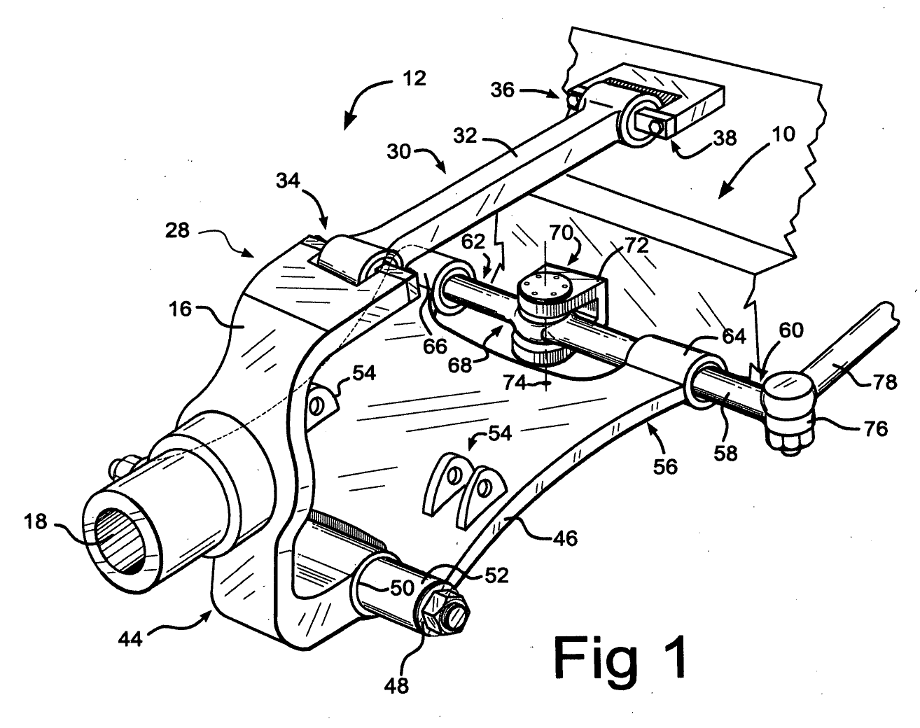

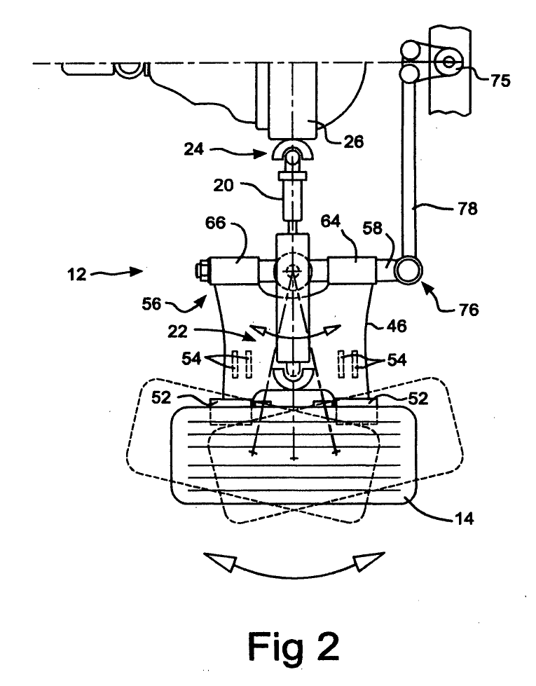

FIG. 1 depicts a portion of a vehicle frame 10, or chassis, on one side of a vehicle, as known to those skilled in the art. Attached to the vehicle frame 10 is one half of a rear wheel steering system 12. An identical structure is located on the other side of the vehicle. As shown in FIG. 2, the rear wheel 14 associated with the steering system 12 may be driven or non-driven however, in the preferred embodiment discussed below, the wheel 14 is driven.

FIG. 1 also depicts a knuckle 16 known to those skilled in the art for rotatably mounting the wheel 14 thereon. Preferably, the knuckle 16 is one which is already mounted in a rear position on the vehicle, but which is not yet configured for steering capability. Thus, a new knuckle, or a specially designed knuckle, is not required to take the place of the existing knuckle 16.

In the preferred embodiment, an aperture 18 is located in the knuckle 16 to receive a drive axle 20 therethrough. As best seen in FIG. 2, the drive axle 20 is of standard configuration having a first end 22 connected to the wheel 14 and a second end 24 connected to a driving mechanism, such as a differential 26. Those skilled in the art will appreciate that a driven wheel, or a drive axle 20, is not required for the present invention.

Referring back to FIG. 1, an upper portion 28 of the knuckle 16 is designed for attachment with a first end 30 of a bar-shaped upper control arm 32. The upper portion 28 may be designed to connect with the upper control arm 32 with a first bar pin bushing 34, as known to those skilled in the art. The first bar pin bushing 34 enables the upper control arm 32 to pivot with respect to the knuckle 16. The second end 36 of the upper control arm 32 is pivotally mounted to the frame 10, preferably with a second bar pin bushing 38.

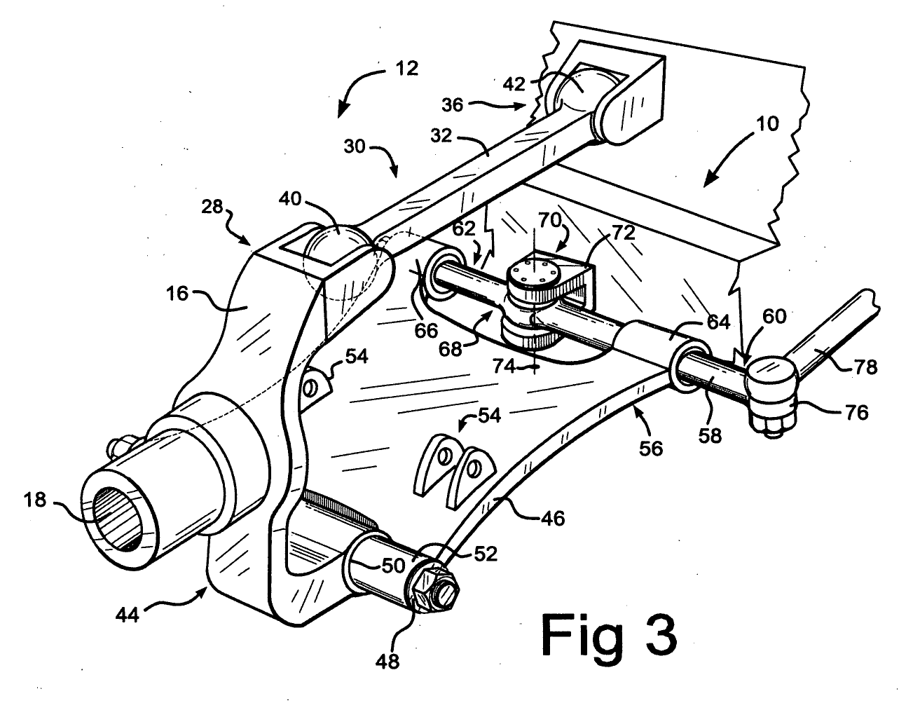

In an alternative embodiment depicted in FIG. 3, the upper portion 28 of the knuckle 16 is designed to be attached with the first end 30 of the upper control arm 32 with a spherical joint, or spherical bearing, 40. The spherical joint, or spherical bearing, 40 increases the articulation and control of the knuckle 16, verses the bar pin bushing 34. The second end 36 of the upper control arm 32 is connected to the frame 10 also with a spherical joint, or spherical bearing, 42.

Referring now to FIG. 1, a lower portion 44 of the knuckle 16 is connected to a lower control arm 46. Preferably, the lower portion 44 is pivotally connected to the lower control arm 46 with an outboard arm 48. The outboard arm 48 is positioned within an aperture 50 in the lower portion 44 of the knuckle 16. The outboard arm 48 extends into two pivotal mountings 52 (only one is shown in FIG. 1) of the lower control arm 46.

The lower control arm 46 is preferably a plate-like structure, although other designs known to those skilled in the art are within the scope of the present invention. The lower control arm 46 also has at least two portions 54 to which one or more elastic members (not shown), such as air shocks, may be secured as known to those skilled in the art. Those skilled in the art will appreciate that any elastic member such as, but not limited to, air springs, shock absorbers, or combinations thereof, may be used without departing from the scope of the present invention.

An inboard portion 56 of the lower control arm 46 is preferably attached to an inboard arm 58. A first end 60 and a second end 62 of the inboard arm 58 extend into a first pivotal mounting 64 and a second pivotal mounting 66, respectively, of the lower control arm 46.

Proximate a midpoint 68 of the inboard arm 58, a gimbal 70 is provided. A housing 72 for the gimbal 70 is secured to the vehicle frame 10. The gimbal 70 is mounted within the housing 72 so as to be free to rotate within the housing 72. By virtue of this housing 72 and the gimbal 70 mounted therein, a vertical steer axis 74 for the system 12 through the gimbal 70 is created. The vertical steer axis 74 is the axis about which the steering system 12 turns. Other structures known to those skilled in the art that provide rotational motion to the lower control arm 46 are within the scope of the present invention.

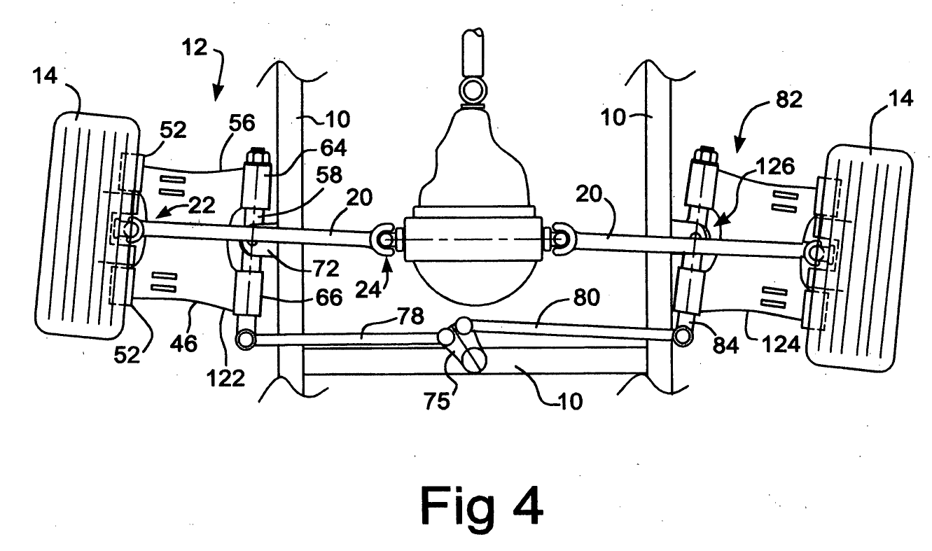

One portion of the inboard arm 58 is secured to a steering actuator 75, as best seen in FIGS. 2 and 4. In the preferred embodiment, an end 76 of the inboard arm 58 is connected to a first tie rod 78 and the first tie rod 78 is connected to the steering actuator 74, as known to those skilled in the art.

As shown in FIG. 4, the steering actuator 75 is preferably connected to the first tie rod 78 and a second tie rod 80. The second tie rod 80 is connected to the other half of the steering system 82 on the other side of the vehicle. The second tie rod 80 is connected to a lower control arm 84, as described above.

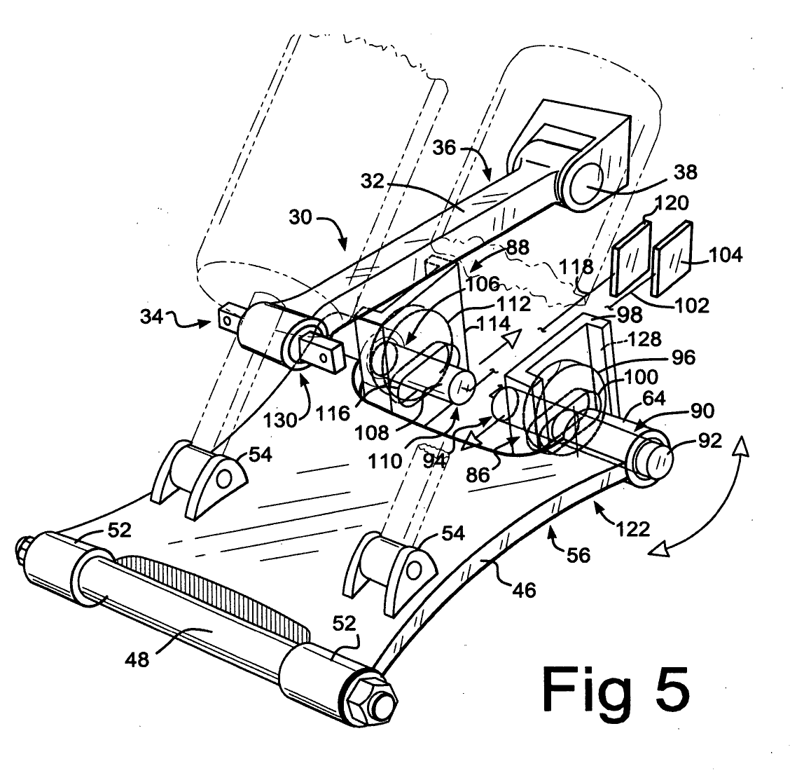

A preferred alternative embodiment of the present invention is depicted in FIG. 5, where the inboard portion 56 of the lower control arm 46 is connected to a first slot and cam system 86 and a second slot and cam system 88. The first slot and cam system 86 has one end 90 of a pin 92 rotatably located through the first pivotal mounting 64 of the lower control arm 46. The other end of the pin 94 extends through a cam 96. The cam 96 is rotatably mounted within a mounting 98 and the mounting is secured to the frame (not shown). The mounting 98 has a slot 100 through which the pin 92 extends. Preferably, the slot 100 is a horizontally oriented oval slot. The oval slot 100 is sized such that the pin 92 can selectively move within it. A tie rod 102, or other structure, is connected to the end 94 of the pin 92 extending through the cam 96. The tie rod 102 is connected to a steering actuator 104 for the first cam and slot system 86.

The second slot and cam system 88 has one end 106 of a pin 108 rotatably located through the second pivotal mounting 66 of the lower control arm 46. The other end 110 of the pin 108 extends through a cam 112. The cam 112 is rotatably mounted within a mounting 114 and the mounting is secured to the frame (not shown). The mounting 114 has a slot 116 through which the pin 108 extends. Preferably, the slot 116 is a horizontally oriented oval slot. The oval slot is sized such that the pin 108 can selectively move within the horizontally oriented slot 116. A tie rod 118, or other structure, is connected to the end 110 of the pin 108 extending through the cam 112. The tie rod 118 is connected to a steering actuator 120 for the second cam and slot system 88.

The steering actuator 75 for the embodiment depicted in FIGS. 2 and 4 and the steering actuators 104, 120 for the first and second cam and slot system 86, 88 of the alternative embodiment may be driven by pneumatic, hydraulic, mechanical and/or electromechanical means. Preferably, the steering actuators 75, 104, 120 are electro-mechanical to provide for precise movement of the lower control arm 46 in an inboard or outboard direction. By way of example only, the steering actuators 75, 104, 120 may be one or more ball ramp actuators as known to those skilled in the art. The steering actuators 75, 104, 120 may also be one or more fluid driven pistons as known to those skilled in the art.

FIG. 5 depicts a bar-shaped upper control arm 32 that is identical to the control arm 32 depicted in FIG. 1. The control arm 32 depicted in FIG. 5 has a first end 30 that is pivotally connected to a knuckle (not shown), as described above, and a second end 36 that is pivotally connected to the frame (not shown).

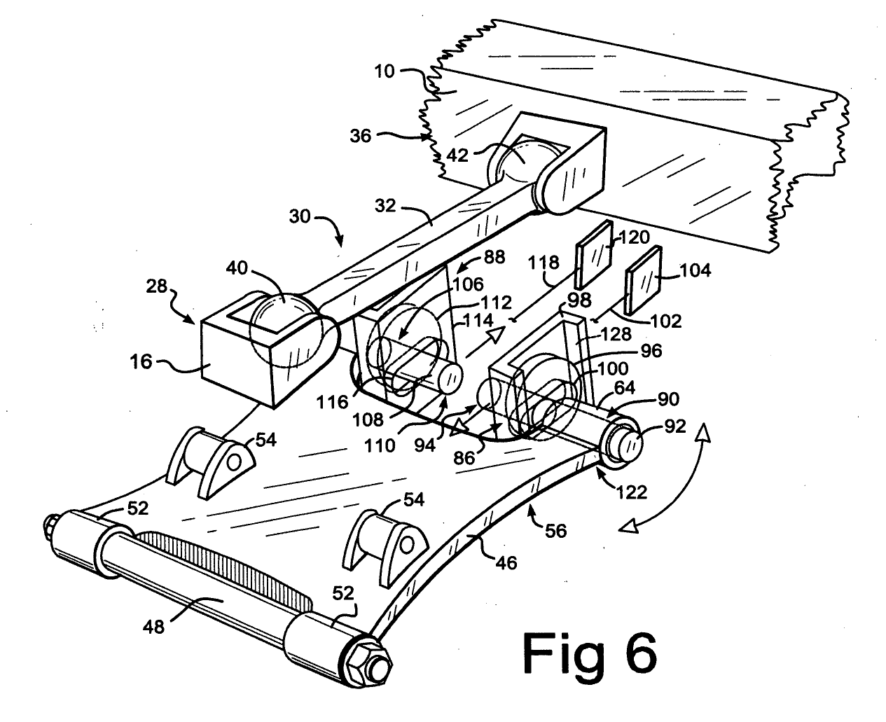

FIG. 6 depicts a variation of the invention depicted in FIG. 5 but now having an upper control arm 32 with a first end 30 fitted with a spherical joint, or spherical bearing, 40. The spherical joint 40 is connected to the knuckle (not shown) and increases the articulation and control of the knuckle verses the bar pin bushing 34. The second end 36 of the upper control arm 32 is connected to the frame 10 with a spherical joint, or spherical bearing.

A method of installing and utilizing the rear axle system 12 of present invention will now be described. The present invention preferably utilizes the knuckle 16, bushings 34, 38 upper and lower control arms 32, 34 and drive axle 20 (if any) of an original axle system, as shown in the accompanying figures. As provided above in the alternative embodiments depicted in FIGS. 3 and 6, the bushings 34, 38 in the upper control arm 32 may be replaced with spherical joints, 40, 42 or spherical bearings, if they are not already in place.

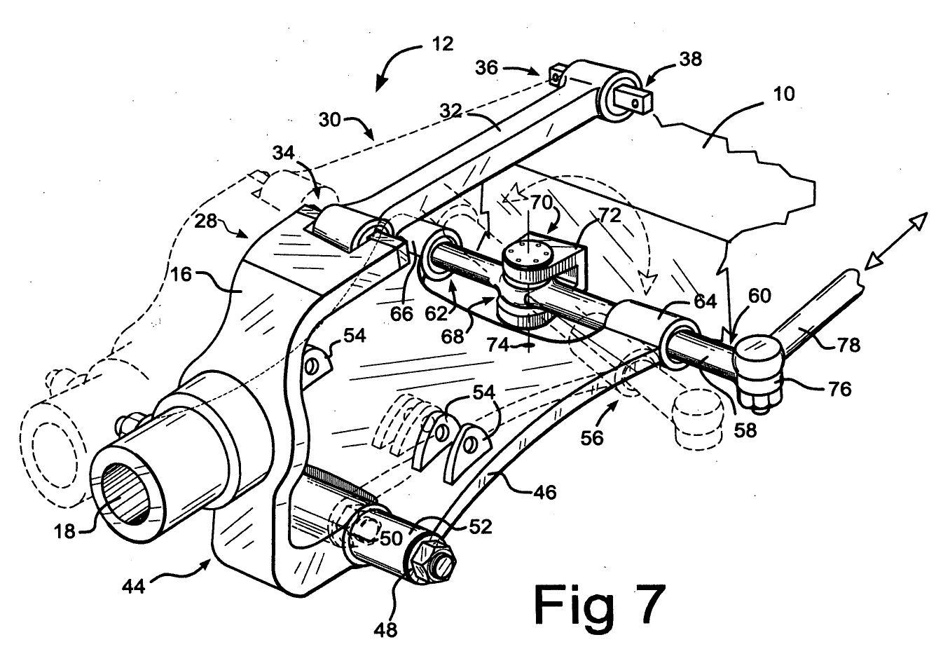

Referring now to FIGS. 2 and 4, at least one actuator 75, as described above, is secured to the vehicle frame 10. The first and second tie rods 78, 80 are secured to the actuator 75 and their respective lower control arms 46, 84. Engagement of the actuator 75 to turn the vehicle wheels pushes one tie rod and pulls the other tie rod. For example, as depicted in FIG. 4, the first tie rod 78 is pushed and the second tie rod 80 is pulled. Pushing the first tie rod 78 pivots an inboard rear portion 122 of the lower control arm 46 in an outboard direction, as shown in FIG. 4 and by the dashed lines in FIG. 7. The lower control arm 46 and knuckle 16 pivot about the gimbal 70 and turn the wheel 14.

As shown in FIG. 4, pulling the second tie rod 80 pulls an inboard rear portion 124 of the lower control arm 84 in an inboard direction. The lower control arm 84 pivots about a gimbal 126, identical to the gimbal 70, and turns the wheel 14. Those skilled in the art will appreciate that by pulling the first tie rod 78 and pushing the second tie rod 80, the wheels 14 can be straightened and, if the actuator 75 remains engaged, the wheels 14 can be turned in the opposite direction.

In the alternative embodiments depicted in FIGS. 5 and 6, the first cam and slot system 86 and second cam and slot system 88 are attached to the lower control arm 46 and the frame 10. Preferably, the original knuckle 16, bushings 34, 38 upper and lower control arms 32, 46 and drive axle 20 (if any) are utilized. One end 90 of the pin 92 is located within the first pivotal mounting 64 of the lower control arm 46. At least an inboard edge 128 of the cam mounting 98 of the first cam and slot system 86 is secured to the vehicle frame 10, such as by welding and/or mechanical fasteners. The other end 94 of the pin 92 is secured to the tie rod 102.

One end 106 of the pin 108 of the second cam and slot system 88 is located through the second pivotal mounting 66 of the lower control arm 46. The cam mounting 114 is secured to the vehicle frame 10. The other end 110 of the pin 108 is secured to the tie rod 118.

Those skilled in the art will appreciate that two cam and slot systems (not shown) are also located on the opposite side of the axle 82.

Movement of the steering system is schematically depicted by the arrows in FIGS. 5 and 6. For example, if the tie rod 102 connected to the first cam and slot system 86 is urged in an outboard direction by the actuator 104, the pin 92 moves within the slot 100 to an outboard position to urge the inboard rear portion 122 of the lower control arm 46 in an outboard direction.

In the preferred embodiment, the tie rod 118 connected to the second cam and slot system 88 is simultaneously urged in an inboard direction by the actuator 120. The pin 108 moves within the slot 116 to an inboard position to urge a front inboard portion 130 of the lower control arm 46 in an inboard direction, which turns the wheel 14. Reversing the movement of the tie rods 102, 118 described above, centers the wheels 14 or turns them in the opposite direction.

Those skilled in the art will readily appreciate that the first cam and slot system 86 and the second cam and slot system 88 can be oriented so that inboard actuation of the tie rods 102, 118 can produce an outboard movement or an inboard movement of the pins 92, 108.

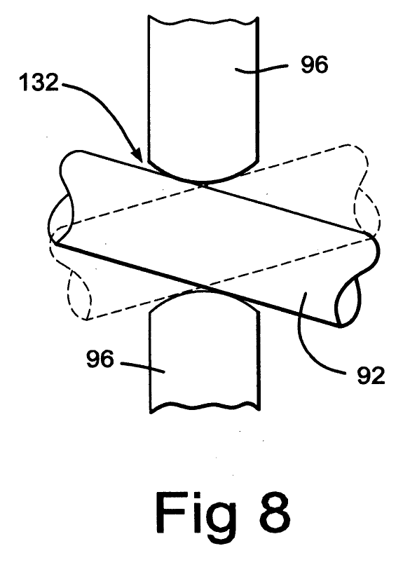

Those skilled in the art will also appreciate that an angle is created between the cams 96, 112 and their respective pins 92, 108 during a turn. The angle between the cams 96, 112 and the pins 92, 108 is accommodated by providing an hourglass shaped hole 132 in each of the cams 96, 112 in lieu of merely a circular hole for pins 92, 108, as shown in FIG. 8. The hourglass shaped hole 132 allows the pins 92, 108 to assume an angle relative to the cams 92, 112.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A rear axle system, comprising:
a vehicle frame;
a knuckle for rotatably mounting a wheel thereon;
an upper control arm having a first portion pivotally connected to said vehicle frame and a second portion pivotally connected to said knuckle;
a lower control arm having a first portion connected to said vehicle frame with at least one gimbal and a second portion pivotally connected to said knuckle; and
a tie rod selectively moveable by at least one actuator, said tie rod connected proximate said first portion of said lower control arm for pivoting said knuckle with said lower control arm.

2. The system of claim 1, wherein a first spherical joint connects said first portion of said upper control arm to said vehicle frame and a second spherical joint connects said second portion of said upper control arm to said knuckle.

3. The system of claim 1, wherein an inboard arm is attached to said first portion of said lower control arm.

4. The system of claim 3, wherein said at least one gimbal is located proximate a midpoint of said inboard arm.

5. The system of claim 1, wherein a steer axis is located through said gimbal about which said lower control arm rotates.

6. The system of claim 3, wherein a lower portion of said knuckle is pivotally connected to an outboard portion of said lower control arm with an outboard arm.

7. The system of claim 1, wherein a drive axle is located through said knuckle to provide drive to said wheel.

8. A method of steering a rear axle system, comprising:
rotating a lower control arm in an inboard direction or an outboard direction about at least one gimbal connecting said lower control arm to a vehicle frame, said rotation enabled by at least one actuator;
turning a knuckle attached to said lower control arm as said lower control arm is rotated about said gimbal; and
pivoting a first end of an upper control arm attached to said knuckle and a second end of said upper control arm attached to said frame as said knuckle is turned.

9. The method of claim 8, wherein said at least one actuator selectively translates at least one tie rod connected to said lower control arm in said inboard direction or said outboard direction.

10. The method of claim 10, wherein said at least one actuator translates a first tie rod and a second tie rod to substantially simultaneously turn a first knuckle and a second knuckle mounted on a single axle.

11. The method of claim 8, wherein said gimbal pivots within a mounting secured to said vehicle frame.

12. The method of claim 8, wherein at least one wheel is rotatably mounted to said knuckle, and a drive axle is located through said knuckle to provide drive to said wheel.

13. The method of claim 12, wherein said wheel turns about a steer axis located through said gimbal.

14. A rear axle system, comprising:
a vehicle frame;
a knuckle for rotatably mounting a wheel thereon;
an upper control arm pivotally connected to said frame and pivotally connected to said knuckle; and,
a lower control arm having an inboard portion moveably connected to said frame with at least one cam and slot system to steer said knuckle and said wheel and an outboard portion pivotally connected to said knuckle.

15. The system of claim 14, wherein said outboard portion of said upper control arm is connected to said knuckle with a spherical joint and said inboard portion of said upper control arm is connected to said frame with a spherical joint.

16. The system of claim 14, wherein a first cam and slot system is connected to a rearward inboard portion of said lower control arm and a second cam and slot system is connected to a forward inboard portion of said lower control arm.

17. The system of claim 16, wherein said first cam and slot system is connected to a first actuator and said second cam and slot system is connected to a second actuator.

18. The system of claim 16, wherein a first pin from said first cam and slot system is rotatably located within a first pivotal mounting on said lower control arm and a second pin from said second cam and slot system is rotatably located within a second pivotal mounting on said lower control arm.

19. A method of steering a rear axle system, comprising:
rotating a lower control arm in an inboard direction or an outboard direction with at least one cam and slot system, said cam and slot system connected to at least one actuator;
turning a knuckle attached to said lower control arm as said lower control arm is rotated by said cam and slot system; and
pivoting a first end of an upper control arm attached to said knuckle and a second end of said upper control arm attached to a vehicle frame.

20. The method of claim 19, wherein a first cam and slot system urges one portion of said lower control arm in either an inboard or an outboard direction and a second cam and slot system urges another portion of said lower control arm in the opposite direction to rotate said lower control arm and turn said knuckle.
